(19) United States
(12) Patent Application Publication
(10) Pub. No.: US 2023/0311935 A1
(43) Pub. Date: Oct. 5, 2023

(54) VEHICLE CONTROL SYSTEM AND VEHICLE CONTROL METHOD

(71) Applicant: HONDA MOTOR CO., LTD., Minato-ku, Tokyo (JP)

(72) Inventors: Mineyuki Yoshida, Wako-shi, Saitama (JP); Yoshinori Izumi, Wako-shi, Saitama (JP)

(21) Appl. No.: 17/921,118

(22) PCT Filed: Dec. 28, 2020
(86) PCT No.: PCT/JP2020/049152

§ 371 Date: Oct. 25, 2022

(51) Int. Cl. B60W 60/00; B60W 50/08; B60W 50/04; B60W 10/20; B60W 50/00

(52) U.S. Cl. CPC B60W 60/001; B60W 50/082; B60W 50/04; B60W 10/20; B60W 50/0098; B60W 30/18163

(57) ABSTRACT

A vehicle control device is set to a second driving mode in which the task is not imposed on the driver and the first steering controller controls steering of the vehicle, sets the driving mode to a first driving mode in which a task of performing a predetermined amount of operations or more on a driving operator is imposed on the driver when the first steering controller is in a state in which the steering is not able to be controlled such that the vehicle travels in a lane in which the vehicle travels, and does not set the driving mode to a driving mode in which the first driving controller controls the vehicle, which is included in a plurality of driving modes and maintains a state in which a second steering controller is made to control the steering when the second steering controller controls the steering.

### TECHNICAL FIELD

The present invention relates to a vehicle control system and a vehicle control method.

### BACKGROUND ART

Conventionally, a vehicle control system that includes an external recognition device group and an actuator group, a first communication means for communicating, by a first traveling control means performing first traveling control of a vehicle, with the external recognition device group, a second communication means for communicating, by the first traveling control means, with the actuator group, a third communication means for communicating, by a second traveling control means performing second traveling control of the vehicle, with the external recognition device group, and a fourth communication means for communicating, by the second traveling control means, with the actuator group has been disclosed (for example, refer to Patent Literature 1). When this control system detects functional deterioration of the vehicle on the basis of communication states of the first communication means, the second communication means, the third communication means, and the fourth communication means, at least one of the first traveling control means and the second traveling control means performs alternative control.

### CITATION LIST

### Patent Literature

### [Patent Literature 1]

PCT International Publication No. WO 2019/116459

### SUMMARY OF INVENTION

### Technical Problem

In the conventional technology, vehicles could not be properly controlled in some cases.

The present invention has been made in consideration of such circumstances, and an object thereof is to provide a vehicle control system and a vehicle control method capable of appropriately controlling vehicles.

### Solution to Problem

A vehicle control device according to the present invention has adopted the following configuration.

(1): A vehicle control device according to one aspect of the present invention includes a first driving controller configured to control steering and acceleration or deceleration of a vehicle, a first steering controller configured to output a control command value according to a state of a steering device of the vehicle on the basis of an instruction of the first driving controller, a second driving controller configured to control the steering and the acceleration or deceleration of the vehicle, a second steering controller configured to output a control command value according to a state of the steering device on the basis of an instruction of the second driving controller, and a mode setter configured to set a driving mode of the vehicle to any one of a plurality of driving modes, including a first driving mode in which a task of performing a predetermined amount of operations or more on a driving operator is imposed on the driver and a second driving mode in which the task is not imposed on the driver and the first steering controller controls the steering of the vehicle, in which the first steering controller controls the steering of the vehicle with preference over control by the second steering controller, and the mode setter sets the driving mode to the first driving mode when the driving mode is set to the second driving mode and the first steering controller is in a state in which the steering is not able to be controlled such that the vehicle travels in a lane in which the vehicle travels, and does not set the driving mode to a driving mode in which the first driving controller controls the vehicle, which is included in the plurality of driving modes, and maintains a state in which the second steering controller is made to control the steering when the second steering controller controls the steering of the vehicle.

(2): In the aspect of (1) described above, the first driving mode is a mode in which the driver performs a predetermined amount of operations or more on the driving operator to control the steering device.

(3): In the aspect of (1) or (2) described above, the mode setter determines that the first steering controller is in a state in which the steering is not able to be controlled when information indicating that the vehicle is not able to be controlled to travel in a lane in which the vehicle travels is acquired from the first steering controller.

(4): In the aspect of any one of (1) to (3) described above, even if the first driving controller requests the first steering controller to perform control such that the vehicle travels in a lane in which the vehicle travels, the mode setter determines that the first steering controller is in the state in which the steering is not able to be controlled when the first steering controller does not execute control according to the request for a predetermined time.

(5): In the aspect of any one of (1) to (4) described above, when an abnormality occurs in the first driving controller, the first steering controller, or a control target of the first driving controller and the first driving controller is not able to control the vehicle, the second driving controller causes the second steering controller to control the steering.

(6): In the aspect of (5) described above, the second driving controller causes the vehicle to decelerate or stop to minimize a movement risk of the vehicle.

(7): A vehicle control method according to still another aspect of the present invention includes controlling, by a first hardware processor, steering and acceleration or deceleration of a vehicle and setting a driving mode of the vehicle to one of a plurality of driving modes including a first driving mode and a second driving mode in which the first driving mode is a driving mode in which a task of performing a predetermined amount of operations or more on a driving operator is imposed on a driver, and the second driving mode is a driving mode in which the task is not imposed on the driver and the first steering controller controls the steering of the vehicle, outputting, by a second hardware processor, a control command value according to a state of a steering device of the vehicle on the basis of an instruction of the first hardware processor, controlling, by a third hardware processor, steering and acceleration or deceleration of the vehicle, outputting, by a fourth hardware processor, a control command value according to the state of the steering device on the basis of an instruction of the third hardware processor, and controlling, by the second hardware processor, the steering of the vehicle with preference over control by the fourth hardware processor, in which the first hardware processor sets the driving mode to the first driving mode when the driving mode is set to the second driving mode and the second hardware processor is in a state in which the steering is not able to be controlled such that the vehicle travels in a lane in which the vehicle travels, and maintains a state in which the fourth hardware processor is made to control the steering without setting the driving mode to a driving mode in which the first hardware processor controls the vehicle, included in the plurality of driving modes, when the fourth hardware processor is controlling the steering of the vehicle.

### Advantageous Effects of Invention

According to the aspects of (1) to (7) described above, it is possible to more appropriately control vehicles.

### BRIEF DESCRIPTION OF DRAWINGS

FIG. 1 is a configuration diagram of a vehicle system using a vehicle control device according to an embodiment.

FIG. 2 is a functional configuration diagram of a first controller and a second controller.

FIG. 3 is a diagram which shows an example of a corresponding relationship among a driving mode, a control state of a host vehicle, and a task.

FIG. 4 is a diagram which shows a vehicle system 1 from another viewpoint.

FIG. 5 is a diagram for describing predetermined conditions (A) to (C).

FIG. 6 is a diagram for describing a condition (A).

FIG. 7 is a diagram for describing a condition I.

FIG. 8 is a diagram for describing a condition for starting a determination on whether the predetermined conditions (A) to (C) are satisfied.

FIG. 9 is a flowchart which shows an example of a flow of processing executed by a mode change processor 154 of a first control device 100.

### DESCRIPTION OF EMBODIMENTS

In the following description, embodiments of a vehicle control system and a vehicle control method of the present invention will be described with reference to the drawings.

[Overall Configuration]

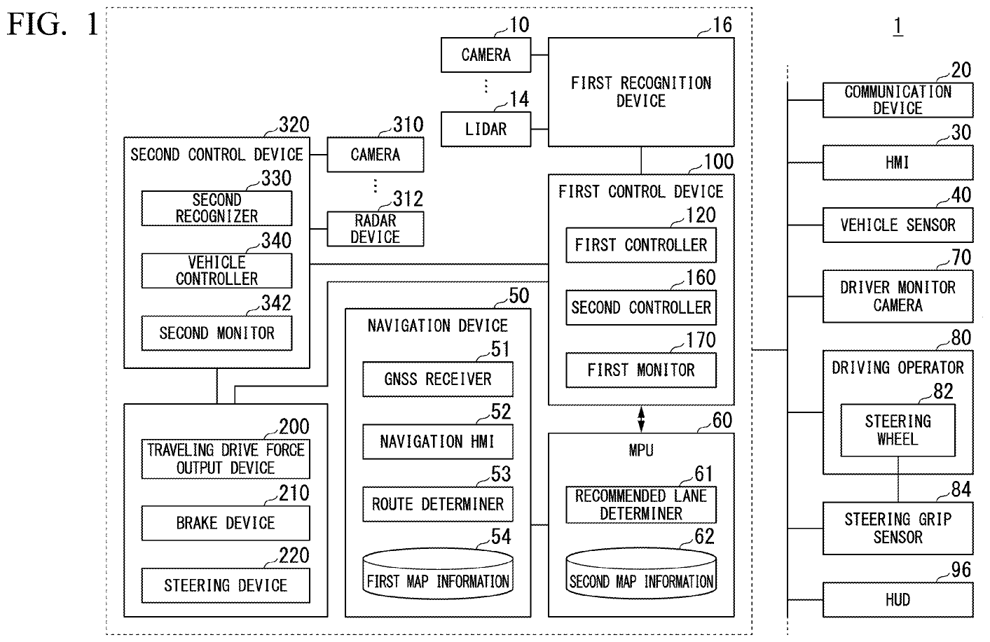

FIG. 1 is a configuration diagram of a vehicle system 1 using a vehicle control device according to an embodiment. A vehicle in which the vehicle system 1 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination of these. The electric motor operates by using electric power generated by a generator connected to the internal combustion engine or discharge power of secondary batteries or fuel cells. In the following description, a vehicle is described as a hybrid vehicle driven by a four-wheel internal combustion engine and an electric motor.

The vehicle system 1 has multiple or redundant functions for controlling the vehicle in a first group and a second group, which will be described below. This improves the reliability of the vehicle system 1.

The vehicle system 1 includes, for example, a camera 10, a light detection and ranging (LIDAR) 14, a first recognition device 16, a communication device 20, a human machine interface (HMI) 30, a vehicle sensor 40, a navigation device 50, a map positioning unit (MPU) 60, a driver monitor camera 70, a driving operator 80, a head up display (HUD) 96, a first control device 100, a traveling drive force output device 200, a brake device 210, and a steering device 220.

Moreover, the vehicle system 1 includes, for example, a camera 310, a radar device 312, and a second control device 320.

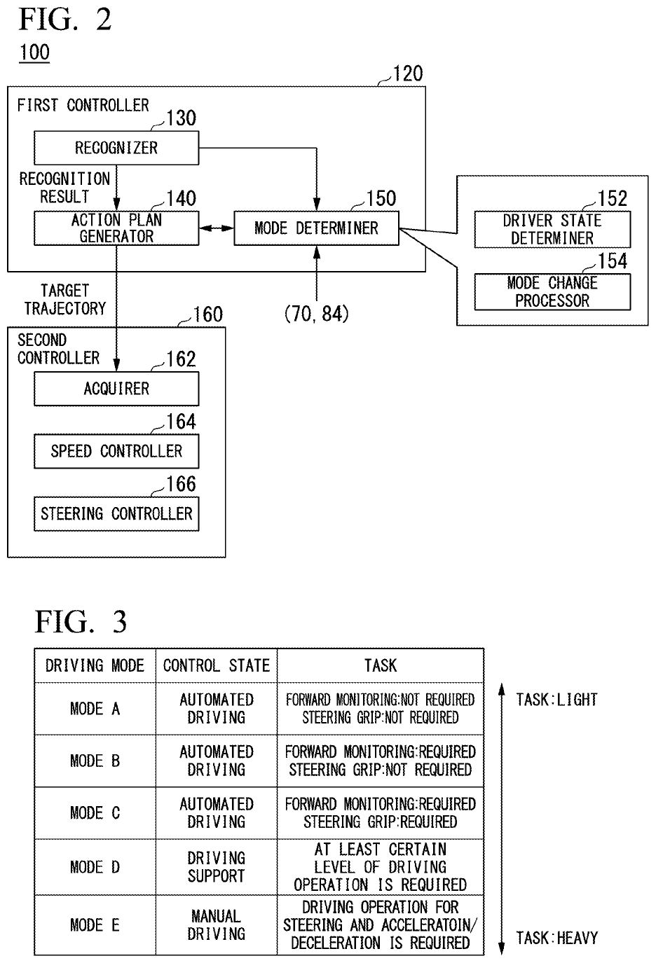

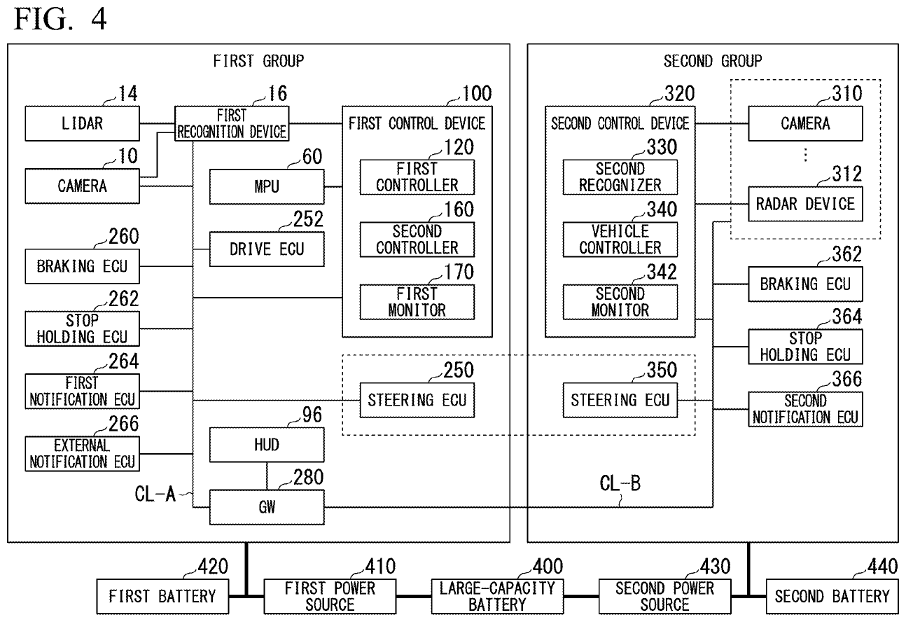

These devices and apparatuses are connected to each other by a multiplex communication line such as a controller area network (CAN) communication line, a serial communication line, a wireless communication network, or the like. The configuration shown in FIG. 1, and FIGS. 2 and 4 to be described below is merely an example, and a part of the configuration may be omitted or another configuration may be added. In addition, a connection mode of the communication line shown in FIG. 1 and FIGS. 2 and 4 to be described below is merely an example, and the connection mode may also be changed as appropriate. Furthermore, each functional constituent may be integrated or may also be distributed. The vehicle system 1 is classified into functional constituents included in the first group and functional constituents included in the second group. Details of the first group and the second group will be described below (refer to FIG. 4). In addition to being shown in FIG. 1, the vehicle system 1 includes, for example, a sonar that detects an object at a short distance, a multi-view camera that captures an image of the surroundings of the vehicle, and the like, but these are not shown.

The camera 10 is, for example, a digital camera that uses a solid-state image sensor such as a charge coupled device (CCD) or a complementary metal oxide semiconductor (CMOS). The camera 10 is attached to an arbitrary place in a vehicle in which the vehicle system 1 is mounted (hereinafter, referred to as a vehicle M). When an image of the front is captured, the camera 10 is attached to an upper part of the front windshield, a back surface of the windshield rear-view mirror, and the like. The camera periodically and repeatedly captures an image of the periphery of the vehicle M. The camera 10 may also be a stereo camera.

The LIDAR 14 irradiates the vicinity of the vehicle M with light (or an electromagnetic wave having a wavelength close to that of light) and measures scattered light. The LIDAR 14 detects a distance to a target on the basis of a time from light emission to light reception. The emitted light is, for example, a pulsed laser beam. The LIDAR 14 is attached to arbitrary place of the vehicle M.

The first recognition device 16 performs sensor fusion processing on results of detection by some or all of the camera 10, the radar device 12, and the LIDAR 14, recognizes the position, type, speed, and the like of the object, and outputs a result of recognition to the first control device 100. The first recognition device 16 may output the results of the detection by the camera 10, the radar device 12, and the LIDAR 14 to the first control device 100 as they are. The first recognition device 16 may be omitted from the vehicle system 1. The first recognition device 16 may also perform sensor fusion processing further using a result of detection by the radar device 312.

The communication device 20 communicates with other vehicles existing in the vicinity of the vehicle M by using, for example, a cellular network, a Wi-Fi network, Bluetooth (registered trademark), or dedicated short range communication (DSRC), or communicates with various server devices via a wireless base station.

The HMI 30 presents various types of information to the occupant of the vehicle M and receives an input operation from the occupant. The HMI 30 includes various display devices, speakers, buzzers, touch panels, switches, keys and the like. The HMI 30 may include a predetermined outputter which is provided on the steering wheel and prompts the occupant to grip the steering wheel, and a HUD.

The vehicle sensor 40 includes various sensors used in control of the vehicle M, such as a vehicle speed sensor that detects a speed of the vehicle M, an acceleration sensor that detects the acceleration, a yaw rate sensor that detects the angular speed around the vertical axis, and an azimuth sensor that detects a direction of the vehicle M.

The navigation device 50 includes, for example, a global navigation satellite system (GNSS) receiver 51, a navigation HMI 52, and a route determiner 53. The navigation device 50 holds first map information 54 in a storage device such as a hard disk drive (HDD) or a flash memory. The GNSS receiver 51 identifies the position of the vehicle M based on a signal received from a GNSS satellite. The position of the vehicle M may be identified or complemented by an inertial navigation system (INS) using an output of the vehicle sensor 40. The navigation HMI 52 includes a display device, a speaker, a touch panel, a key, and the like. The navigation HMI 52 may be partially or entirely shared with the HMI 30 described above. The route determiner 53 determines, for example, a route from the position of the vehicle M (or an arbitrary position to be input) identified by the GNSS receiver 51 to a destination to be input by the occupant using the navigation HMI 52 (hereinafter, a route on a map) with reference to the first map information 54. The first map information 54 is, for example, information in which a road shape is expressed by a link indicating a road and nodes connected by a link. The first map information 54 may include a road curvature, point of interest (POI) information, and the like. A route on a map is output to the MPU 60. The navigation device 50 may perform route guidance using the navigation HMI 52 based on the route on a map. The navigation device 50 may be realized by, for example, a function of a terminal device such as a smartphone or a tablet terminal owned by the occupant. The navigation device 50 may transmit a current position and a destination to a navigation server via the communication device 20 and acquire a route equivalent to the route on a map from the navigation server.

The MPU 60 includes, for example, a recommended lane determiner 61, and holds second map information 62 in a storage device such as an HDD or a flash memory. The recommended lane determiner 61 divides the route on a map provided from the navigation device 50 into a plurality of blocks (for example, divides every 100 [m] in a vehicle traveling direction), and determines a recommended lane for each block with reference to the second map information 62. The recommended lane determiner 61 determines which numbered lane from the left to drive. When a branch place is present on the route on a map, the recommended lane determiner 61 determines a recommended lane so that the vehicle M can travel on a reasonable route to proceed to the branch destination. In addition, the MPU 60 recognizes the position of the vehicle M on the basis of a detection result of a gyro sensor (not shown), the position of the vehicle M specified by the GNSS receiver 51, and the like.

The second map information 62 is map information with higher accuracy than the first map information 54. The second map information 62 includes, for example, information on a center of a lane, information on a boundary of the lane, and the like. In addition, the second map information 62 may include road information, traffic regulation information, address information (addresses/zip codes), facility information, telephone number information, and the like. The second map information 62 may be updated at any time by the communication device 20 communicating with another device. The second map information 62 stores information indicating the position and range of a zebra zone (guide zone). The zebra zone is a road marking for guiding traveling of the vehicle M. The zebra zone is, for example, a marking represented by a striped pattern.

The driver monitor camera 70 is, for example, a digital camera using a solid-state image sensor such as a CCD or CMOS. The driver monitor camera 70 is attached to an arbitrary place on the vehicle M with a position and a direction in which the head of an occupant (hereinafter referred to as a driver) seated in the driver's seat of the vehicle M can be imaged from the front (in a direction in which the face is imaged). For example, the driver monitor camera 70 is attached to an upper part of a display device provided in a center of an instrument panel of the vehicle M.

The driving operator 80 includes, for example, an accelerator pedal, a brake pedal, a shift lever, and other operators in addition to a steering wheel 82. The driving operator 80 has a sensor that detects the amount of operation or a presence or absence of an operation attached thereto, and a result of detection is output to the first control device 100, the second control device 320, or some or all of the traveling drive force output device 200, the brake device 210, and the steering device 220. A steering grip sensor 84 is attached to the steering wheel 82. The steering grip sensor 84 is realized by a capacitance sensor or the like, and outputs a signal capable of detecting whether the driver is gripping the steering wheel 82 (meaning that the driver is in contact with the steering wheel 82 in a state in which force can be applied) to the first control device 100 or the second control device 320.

For example, the HUD 96 projects an image onto a part of the front windshield in front of the driver's seat so that the eyes of the occupant seated in the driver's seat can visually recognize a virtual image. The HUD 96, for example, causes the occupant to visually recognize information for supporting driving. The information for supporting driving is, for example, a speed of a vehicle or a direction to a destination. The HUD 96 is controlled by a control device (not shown) or a first control device 100.

The first control device 100 includes, for example, a first controller 120, a second controller 160, and a first monitor 170. The first controller 120, the second controller 160, and the first monitor 170 are realized by, for example, a hardware processor such as a central processing unit (CPU) executing a program (software), respectively. Some or all of these components may be realized by hardware (a circuit unit; including circuitry) such as large-scale integration (LSI), an application specific integrated circuit (ASIC), a field-programmable gate array (FPGA), or a graphics processing unit (GPU), or may be realized by software and hardware in cooperation. A program may be stored in advance in a device (a storage device having a non-transitory storage medium) such as an HDD or flash memory of the first control device 100, or may be stored in a detachable storage medium such as a DVD or a CD-ROM and installed in the HDD or flash memory of the first control device 100 by the storage medium (non-transitory storage medium) being attached to a drive device.

FIG. 2 is a functional configuration diagram of the first controller 120 and the second controller 160. The first controller 120 includes, for example, a recognizer 130, an action plan generator 140, and a mode determiner 150. The first controller 120 realizes, for example, a function by artificial intelligence (AI) and a function of a predetermined model in parallel. For example, a function of “recognizing an intersection” may be realized by executing both recognition of an intersection by deep learning and recognition based on a predetermined condition (a signal for pattern matching, a road sign, or the like) in parallel, and scoring and comprehensively evaluating the both. As a result, reliability of automated driving is ensured.

The recognizer 130 recognizes states such as a position, a speed, and an acceleration of an object in the vicinity of the vehicle M on the basis of the information input from the camera 10 and the LIDAR 14 via the first recognition device 16. The position of an object is recognized as, for example, a position on absolute coordinates with a representative point (a center of gravity, a center of drive axis, or the like) of the vehicle M set as the origin, and is used for control. The position of an object may be represented by a representative point such as the center of gravity or the corner of the object, or may be represented by an expressed area. The “state” of the object may include the acceleration or jerk of the object, or a “behavioral state” (for example, whether the vehicle is changing the lane or is about to change the lane).

The recognizer 130 recognizes, for example, a lane (a traveling lane) in which the vehicle M is traveling. For example, the recognizer 130 compares a pattern of road lane markings obtained from the second map information 62 (for example, an arrangement of solid lines and broken lines) and a pattern of road lane markings in the vicinity of the vehicle M recognized from an image captured by the camera 10 to recognize the traveling lane. The recognizer 130 may also recognize the traveling lane by recognizing a traveling road boundary (road boundary) including not only road lane markings but also road lane markings, shoulders, curbs, medians, guardrails, and the like. In this recognition, the position of the vehicle M acquired from the navigation device 50 and a result of processing by INS may be taken into account. The recognizer 130 recognizes temporary stop lines, obstacles, red lights, tollhouses, and other road events.

The recognizer 130 recognizes the position and posture of the vehicle M with respect to the traveling lane when the traveling lane is recognized. The recognizer 130 may recognize, for example, a deviation of a reference point of the vehicle M from the center of the lane and an angle of the vehicle M formed against a line connecting the center of the lane in a traveling direction of the vehicle M as relative position and posture of the vehicle M with respect to the traveling lane. Instead, the recognizer 130 may recognize the position of the reference point of the vehicle M with respect to any side end (road marking lines or road boundaries) of the traveling lane as the relative position of the vehicle M with respect to the traveling lane.

In principle, the action plan generator 140 travels in a recommended lane determined by the recommended lane determiner 61, and, furthermore, generates a target trajectory on which the vehicle M will automatically travel (regardless of an operation of a driver) in the future to be able to respond to surrounding conditions of the vehicle M. The target trajectory includes, for example, a speed element. For example, the target trajectory is expressed as a sequence of points (trajectory points) to be reached by the vehicle M. The trajectory point is a point to be reached by the vehicle M for each predetermined traveling distance (for example, about several [m]) along a road, and, separately, a target speed and a target acceleration for each predetermined sampling time (for example, about decimal point number [sec]) are generated as a part of the target trajectory. In addition, the trajectory point may be a position to be reached by the vehicle M at a corresponding sampling time for each predetermined sampling time. In this case, information on the target speed and target acceleration is expressed by an interval between trajectory points.

The action plan generator 140 may set an event of automated driving when a target trajectory is generated. The event of automated driving includes a constant-speed traveling event, a low-speed following traveling event, a lane change event, a branching event, a merging event, a takeover event, and the like. The action plan generator 140 generates a target trajectory according to an event to be started.

The mode determiner 150 determines a driving mode of the vehicle M to be one of a plurality of driving modes in which tasks imposed on the driver are different. The mode determiner 150 includes, for example, a driver state determiner 152 and a mode change processor 154. These individual functions will be described below.

FIG. 3 is a diagram which shows an example of a corresponding relationship among a driving mode, a control state of the vehicle M, and a task. The driving mode of the vehicle M has, for example, five modes from a mode A to a mode E. The control state, that is, a degree of automation of driving control of the vehicle M, is the highest in the mode A, then decreases in order of a mode B, a mode C, and a mode D, and is the lowest in the mode E. On the contrary, the task imposed on the driver is the lightest in the mode A, then becomes heavier in the order of the mode B, the mode C, and the mode D, and is the heaviest in the mode E. Since the control state is not automated driving in the modes D and E, the first control device 100 is responsible for ending control related to automated driving and shifting to driving support or manual driving. Content of each driving mode will be exemplified below.

In the mode A, the control state is a state of automated driving, and neither forward monitoring nor gripping of the steering wheel 82 (steering gripping in FIG. 3) is imposed on the driver. However, even in the mode A, the driver is required to be in a position to quickly shift to manual driving in response to a request from the system that mainly uses the first control device 100. The term “automated driving” herein means that both steering and acceleration or deceleration are controlled without depending on the driver's operation. The front means a space in the traveling direction of the vehicle M which is visually recognized through the front windshield. The mode A is, for example, a driving mode which can be executed when the vehicle M is traveling at a predetermined speed (for example, about 50 [km/h]) or less on a motorway such as an expressway, and a condition such as presence of a preceding vehicle to be followed is satisfied, and may be called as traffic jam pilot (TJP). When this condition is no longer satisfied, the mode determiner 150 changes the driving mode of the vehicle M to the mode B.

In the mode B, the driver is in a driving support state, and a task of monitoring the front of the vehicle M (hereinafter referred to as “forward monitoring”) is imposed on the driver (or monitoring around the vehicle M is imposed), but the task of gripping steering wheel 82 is not imposed. In the mode C, the driver is in the driving support state, and the task of forward monitoring and the task of gripping the steering wheel 82 are imposed on the driver. The mode D is a driving mode that requires a certain amount of driver's driving operation (for example, an operation of an operation amount less than a predetermined amount with respect to the steering wheel) for at least one of steering and acceleration or deceleration of the vehicle M. For example, in the mode D, a driving support such as adaptive cruise control (ACC) and a lane keeping assist system (LKAS) is performed. LKAS is a function in which the steering of the vehicle M is controlled so that the vehicle M travels in the vicinity of the center of a lane in which the vehicle M travels, or travels in the lane or so as not to deviate from the lane. In the mode E, the driver is in a state of manual driving which requires a driving operation of the driver for both steering and acceleration or deceleration. In both the mode D and the mode E, the task of monitoring the front of the vehicle M is naturally imposed on the driver. In each mode, peripheral monitoring may be imposed instead of forward monitoring. Periphery means a space in the periphery of the host vehicle M, visually recognized by the driver at the time of manual driving. In the following description, it is described that “forward monitoring” is imposed.

The first control device 100 (and the driving support device (not shown)) executes an automatic lane change according to the driving mode. The automatic lane change includes a lane change (1) by a system request and a lane change (2) by a driver's request. The automatic lane change (1) includes an automatic lane change for overtaking, performed when a speed of a preceding vehicle is lower than a speed of the host vehicle by a reference or more, and an automatic lane change for traveling toward a destination (a lane change due to a change in a recommended lane). The lane change (2) is, when conditions related to the speed and positional relationship with surrounding vehicles are satisfied, a lane change of the host vehicle M in an operating direction when the turn signal is operated by the driver.

The first control device 100 does not execute either automatic lane change (1) or (2) in the mode A. The first control device 100 executes both of the lane changes (1) and (2) in the modes B and C. A driving support device (not shown) does not execute the automatic lane change (1) but executes the lane change (2) in the mode D. In the mode E, neither the automatic lane change (1) nor (2) is executed.

The mode determiner 150 changes the driving mode of host vehicle M to a driving mode in which a task is heavier when the task related to a determined driving mode (hereinafter referred to as a current driving mode) is not executed by the driver.

The mode determiner 150 changes the driving mode of the vehicle M to a driving mode in which a task is heavier when a task related to the determined driving mode (hereinafter referred to as the current driving mode) is not executed by the driver.

For example, when the driver is in a position where he/she cannot shift to manual driving in response to a request from the system (for example, when he/she continues to look outside a permissible area or when a sign that driving becomes difficult is detected) in the mode A, the mode determiner 150 performs control such as prompting the driver to shift to manual driving by using the HMI 30 and a predetermined outputter that prompts the occupant to grip the steering wheel, moving the vehicle M to the shoulder and gradually stopping it if the driver does not respond, and stopping automated driving. After the automated driving is stopped, the vehicle M is in a state of the mode D or the mode E, and the vehicle M can be started by manual driving of the driver. In the following description, the same applies to “stopping automated driving.” When the driver is not monitoring the front in the mode B, the mode determiner 150 performs control such as prompting the driver to monitor the front using the HMI 30 or a predetermined outputter, moving the vehicle M to the shoulder and gradually stopping it if the driver does not respond, and stopping automated driving. If the driver is not monitoring the front in the mode C, or is not gripping the steering wheel 82, the mode determiner 150 performs control such as prompting the driver to perform forward monitoring by using the HMI 30 or a predetermined outputter and/or to grip the steering wheel 82, moving the vehicle M to a road shoulder and gradually stopping it if the driver does not respond, and stopping automated driving.

The driver state determiner 152 monitors a state of the driver for the mode change described above, and determines whether the state of the driver is a state according to a task. For example, the driver state determiner 152 analyzes an image captured by the driver monitor camera 70 to perform posture estimation processing, and determines whether the driver is in a position where he/she cannot shift to manual driving in response to a request from the system. The driver state determiner 152 analyzes the image captured by the driver monitor camera 70 to perform line-of-sight estimation processing, and determines whether the driver is monitoring the front.

The mode change processor 154 performs various types of processing for mode change. For example, the mode change processor 154 instructs the action plan generator 140 to generate a target trajectory for shoulder stop, gives an operation instruction to a driving support device (not shown), or controls the HMI 30 to prompt the driver to take action. Details of the processing of the mode change processor 154 will be described below.

Returning to the description of FIG. 2, the second controller 160 controls the traveling drive force output device 200, the brake device 210, and the steering device 220 such that the vehicle M passes through a target trajectory generated by the action plan generator 140 at a scheduled time.

The second controller 160 includes, for example, an acquirer 162, a speed controller 164, and a steering controller 166. The acquirer 162 acquires information on a target trajectory (trajectory points) generated by the action plan generator 140 and stores it in a memory (not shown). The speed controller 164 controls the traveling drive force output device 200 via the drive ECU 252 to be described below and controls the brake device 210 via the braking ECU (260 or 362) on the basis of a speed element associated with the target trajectory stored in the memory. The steering controller 166 controls the steering device 220 via the steering ECU (250 or 350) according to a degree of bending of the target trajectory stored in the memory. Processing of the speed controller 164 and the steering controller 166 is realized by, for example, a combination of feedforward control and feedback control. As an example, the steering controller 166 executes feedforward control according to a curvature of a road in front of the vehicle M and feedback control based on a deviation from the target trajectory in combination. The speed controller 164 described above may be integrated into the drive ECU 252 or the braking ECU. The steering controller 166 described above may be integrated into the steering ECU.

Returning to the description of FIG. 1, details of the first monitor 170 will be described below.

The traveling drive force output device 200 outputs a traveling drive force (torque) for the vehicle M to travel to the drive wheels. The traveling drive force output device 200 is, for example, a combination of an internal combustion engine, a motor, a transmission, and the like.

The brake device 210 includes, for example, a brake caliper, a cylinder that transmits a hydraulic pressure to the brake caliper, and an electric motor that generates a hydraulic pressure in the cylinder. The brake device 210 may include a mechanism for transmitting a hydraulic pressure generated by an operation of a brake pedal included in the driving operator 80 to the cylinder via a master cylinder as a backup. The brake device 210 is not limited to the configuration described above, and may be an electronically controlled hydraulic brake device that controls an actuator according to information input from the second controller 160 to transmit the hydraulic pressure of the master cylinder to the cylinder.

The steering device 220 includes, for example, an electric motor. The electric motor changes, for example, a direction of a steering wheel by applying a force to a rack and pinion mechanism.

The camera 310 is, for example, a digital camera using a solid-state image sensor such as a CCD or CMOS. The camera 310 is attached to arbitrary place of the vehicle M. The camera 310, for example, periodically and repeatedly captures images of the periphery of the vehicle M. The camera 10 may be a stereo camera.

The radar device 312 emits radio waves such as millimeter waves to the periphery of the vehicle M, and also detects radio waves (reflected waves) reflected by an object to detect at least the position (the distance and orientation) of the object. The radar device 312 is attached to arbitrary place of the vehicle M. The radar device 312 may detect the position and speed of the object by a frequency modulated continuous wave (FM-CW) method.

The second control device 320 includes, for example, a second recognizer 330, a vehicle controller 340, and a second monitor 342. The second recognizer 330, the vehicle controller 340, and the second monitor 342 are realized by, for example, a hardware processor such as a CPU executing a program (software). Some or all of these components may be realized by hardware (circuit part; including circuitry) such as an LSI, an ASIC, an FPGA, and a GPU, or may be realized by software and hardware in cooperation. The program may be stored in advance in a device (a storage device including a non-transient storage medium) such as an HDD or flash memory of the second control device 320, or may be stored in a detachable storage medium such as a DVD or a CD-ROM and installed in the HDD or flash memory of the second control device 320 by the storage medium (the non-transient storage medium) being attached to a drive device.

The second recognizer 330 performs sensor fusion processing on the results of detection from some or all of the camera 310 and the radar device 312, and recognizes the position, type, speed, and the like of the object.

The vehicle controller 340 executes the same processing as the first controller 120 and the second controller 160 to execute the automated driving of the vehicle M. However, processing performance of the first controller 120 and the second controller 160 (the first control device 100) is higher than processing performance of the vehicle controller 340 (the second control device 320). Reliability of the processing performance of the first controller 120 and the second controller 160 is higher than reliability of the processing performance of the vehicle controller 340. For this reason, automated driving by the first controller 120 and the second controller 160 is smoother than automated driving by the vehicle controller 340. Details of the second monitor 342 will be described below.

[First Group and Second Group]

FIG. 4 is a diagram which shows the vehicle system 1 from another viewpoint. The first group and the second group will be described with reference to FIG. 4. Description of the functional constituents described with reference to FIGS. 1 and 2 will be omitted.

(First Group)

The camera 10, the LIDAR 14, the first recognition device 16, the MPU 60, the HUD 96, the first control device 100, the steering electronic control unit (ECU) 250, the drive ECU 252, the braking ECU 260, a stop holding ECU 262, a first notification ECU 264, an external notification ECU, and a GW 280 are included, for example, in the first group.

The steering ECU 250 controls the steering device 220 in cooperation with the first control device 100. For example, the steering ECU 250 controls the steering of the vehicle M by outputting a control command value according to a state (for example, a current state) of the steering device 220 on the basis of an instruction of the first control device 100. The steering ECU 250 drives the electric motor according to the information input from the second controller 160 and changes the direction of the steering wheel. The steering ECU 250 controls steering according to the operation of the driver with respect to the steering wheel. The steering ECU 250 controls steering using information input from the electric motor that outputs a driving force for steering, a sensor that detects the amount of rotation of the electric motor, and a torque sensor that detects steering torque, or provides the second controller 160 with this information. The steering ECU 250 controls the steering of the vehicle M with preference over control by the steering ECU 350 described below.

The drive ECU 252 controls the traveling drive force output device 200 in cooperation with the first control device 100. The drive ECU 252 outputs a control command value based on information input from a sensor provided in the driving operator 80 and controls the traveling drive force output device 200. The drive ECU 252 controls an internal combustion engine or an electric motor or switches shift stages of an automatic transmission on the basis of, for example, the information input from a sensor that detects the operation amount of the accelerator pedal, the operation amount of the brake pedal, and the vehicle speed.

The braking ECU 260 controls the brake device 210 in cooperation with the first control device 100. The braking ECU 260 outputs a control command value based on the information input from the second controller 160 to control the electric motor so that brake torque corresponding to a braking operation is output to each wheel. The braking ECU 260 and the brake device 210 function as, for example, an electric servo brake (ESB). The braking ECU 260 controls, for example, distribution of a braking force of the brake device 210 and a braking force of regenerative braking of the electric motor.

The stop holding ECU 262 controls an electric parking lock device provided in the automatic transmission. The electric parking lock device locks an internal mechanism of the automatic transmission, for example, when a P range (a parking range) is selected.

The first notification ECU 264 controls an in-vehicle outputter that notifies of information in a vehicle. The in-vehicle outputter includes, for example, an outputter provided on the steering wheel. This outputter lights up, for example, when the occupant of the vehicle M needs to grip the steering wheel. The in-vehicle outputter also includes a mechanism that vibrates a seat belt to prompt the occupant to grip the steering wheel and to perform a predetermined operation.

The external notification ECU 266 controls a vehicle-external outputter that notifies of information to an outside of the vehicle. The vehicle-external outputter is, for example, a turn signal. The external notification ECU 266 controls the turn signal to notify the outside of the vehicle of the traveling direction of the vehicle M or to turn on an emergency blinking indicator lamp (a hazard lamp).

The GW 280 relays a communication line CL-A and a communication line CL-B. For example, the camera 10, the first recognition device 16, the first control device 100, the drive ECU 252, the braking ECU 260, the stop holding ECU 262, the first notification ECU 264, and the external notification ECU 266 are connected to the communication line CL-A. For example, the camera 310, the radar device 312, the second control device 320, the steering ECU 350, the braking ECU 362, the stop holding ECU 364, and the second notification ECU 366 are connected to the communication line CL-B.

(Second Group)

The camera 310, the radar device 312, the second control device 320, the steering ECU 350, the braking ECU 362, the stop holding ECU 364, the steering grip sensor 84, and the second notification ECU 366 are included in, for example, the second group.

The steering ECU 350 controls the steering device 220 in cooperation with the second control device 300. For example, the steering ECU 350 controls the steering of the vehicle M by outputting a control command value according to the state (for example, the current state) of the steering device 220 on the basis of an instruction of the second control device 300. The steering ECU 350 controls the steering using the information input from the electric motor that outputs a driving force for steering, the sensor that detects the amount of rotation of the electric motor, and the torque sensor that detects steering torque.

The braking ECU 362 controls the brake device 210 in cooperation with the second control device 300. The braking ECU 362 outputs a control command value based on information input from the vehicle controller 340 to control the electric motor so that a brake torque corresponding to a braking operation is output to each wheel. The braking ECU 362 realizes vehicle stability assist (VSA). Based on results of detection by the yaw rate sensor and the acceleration sensor, the braking ECU 362 suppresses occurrence of gliding caused by the wheels being locked when sudden braking or braking on a low friction road is applied, suppresses slippage of the wheels at the time of starting or stopping a vehicle, or furthermore, suppresses occurrence of skidding by controlling a posture of the vehicle M when turning.

The stop holding ECU 364 controls the electric parking brake (EPB) to keep the vehicle M stopped. The electric parking brake has a mechanism for locking rear wheels. The stop holding ECU 364 controls the electric parking brake to lock and unlock the rear wheels.

The second notification ECU 366 controls the instrument. The instrument is an instrument that displays various types of information such as a vehicle speed and fuel consumption, which is provided in front of the driver's seat.

The first control device 100 is an example of the first hardware processor. The steering ECU 250 is an example of a second hardware processor. The second control device 300 is an example of the third hardware processor. The steering ECU 350 is an example of a fourth hardware processor. These processors execute various types of processing when a hardware processor such as a CPU executes a program (software) stored in a storage device.

[First Monitor and Second Monitor]

The first monitor 170 monitors the state of some or all of the functional constituents (devices having the functional constituents) included in the second group connected via the GW 280. The first monitor 170 acquires, for example, information transmitted by a communication-destination device, and determines whether an abnormality is present in the communication-destination device on the basis of the acquired information. The presence of an abnormality is, for example, a state in which the communication-destination device cannot be controlled to a state intended by the second control device 320. The presence of an abnormality includes, for example, a defect in a device, a defect in a function of the device, deterioration in the function, a state in which communication with the device is different from a reference communication state, and the like. The information transmitted by the communication-destination device is a result of self-diagnosis of the connection-destination device or a predetermined flag transmitted from a connection-destination device. For example, the first monitor 170 determines that an abnormality is present in the communication-destination device when information including the result of the self-diagnosis indicating an abnormality and a flag indicating an abnormality is transmitted from the connected device. In addition, when the first monitor 170 cannot communicate with the connection-destination device or the communication is delayed, it may consider that the communication-destination device has an abnormality.

The second monitor 342 monitors the state of some or all of the functional constituents included in the first group connected via the GW 280. The second monitor 342 acquires information transmitted by a communication-destination device, and determines whether an abnormality is present in the communication-destination device on the basis of the acquired information. The presence of an abnormality is, for example, a state in which the communication destination device cannot be controlled to a state intended by the first control device 100. The presence of an abnormality includes, for example, a defect in the device, a defect in a function of the device, deterioration in the function, a state in which communication with the device is different from a reference communication state, and the like. The abnormality of the communication destination device includes, for example, a state similar to the state described in the description of the first monitor 170.

The second control device 320 executes automated driving in place of the first control device 100 when an abnormality occurs in an apparatus or device included in the first group. For example, when an abnormality occurs in the steering ECU 250, the braking ECU 260, the stop holding ECU 262, or control target apparatuses or devices of these among the apparatuses and devices included in the first group, the second control device 320 controls the steering ECU 350, the braking ECU 362, the stop holding ECU 364, or the control target apparatuses or devices of these to execute automated driving. The automated driving in this case is, for example, automated driving of the fail operation function (FOF) mode (degeneration control mode). The FOF mode is a mode executed to minimize a movement risk of the vehicle. In the FOF mode, the vehicle system 1 requests the driver to manually operate the vehicle M, the vehicle M does not deviate from a predetermined area such as a road or a shoulder, and the vehicle M is controlled not to be excessively close to nearby vehicles. The vehicle system 1 requests the occupant of the vehicle M to drive manually, and even if the occupant does not respond to the request, the vehicle system 1 outputs a driving change request notification requesting the occupant to perform manual driving to the outputter (for example, the HMI 30, the HUD 270, a predetermined outputter prompting gripping of the steering wheel, etc.). In this case, for example, the vehicle system 1 may control the vehicle M by performing control that is currently possible. The vehicle system 1 may decelerate the vehicle M to stop the vehicle M as it is, or may stop the vehicle M at a position where the vehicle M can be stopped.

[Power Supply]

Further, the vehicle system 1 includes, for example, a large-capacity battery 400, a first power supply 410, a first battery 420, a second power supply 430, and a second battery 440.

The large-capacity battery 400 is a rechargeable battery such as a lithium-ion battery. An electric motor for driving is driven by an electric power supplied by the large-capacity battery 400. The large-capacity battery 400 is charged with regenerative power generated by the electric motor.

The first power supply 410 steps down an output voltage of the large-capacity battery 400 and supplies power of the large-capacity battery 400 to each functional constituent of the first group. The first battery 420 is, for example, a 12 V lead battery. For example, when electric power is not supplied from the large-capacity battery 400 to the functional constituents of the first group, electric power of the first battery 420 is supplied to the functional constituents of the first group. In addition, the first battery 420 supplies the electric power to the navigation device 50, the communication device 20, the driver monitor camera 70, and some sensors included in the vehicle sensor 40.

The second power supply 430 steps down the output voltage of the large-capacity battery 400 and supplies the electric power of the large-capacity battery 400 to each functional constituent of the second group. The second battery 440 is, for example, a 12 V lead battery. For example, when electric power is not supplied from the large-capacity battery 400 to the functional constituents of the second group, electric power of the second battery 440 is supplied to the functional constituents of the second group. Moreover, the second battery 440 supplies the electric power to the steering grip sensor 84 and some sensors included in the vehicle sensor 40.

[Restriction of Driving Mode]

When a task of performing a predetermined amount of operation or more on steering wheel is not imposed on the driver, the driving mode is set to the second driving mode in which the steering ECU 250 (the first steering controller) controls the steering of the vehicle M, and the steering ECU 250 is in a state in which steering is not able to be controlled (in a state in which an LKAS function is not able to be executed) such that the vehicle M travels in a lane (or near a center of the lane) in which the vehicle M travels, the mode change processor 154 sets the driving mode to the first driving mode in which the task of performing a predetermined amount of operation or more on the steering wheel is imposed on the driver. The second driving mode is, for example, the modes A to D, and the first driving mode is, for example, the mode E (the mode in which the vehicle M is controlled by the operation of the driver). Moreover, the second driving mode or the first driving mode may be any mode. In this case, for example, the first driving mode is a mode in which the task is heavier than that of the second driving mode.

The mode change processor 154 does not set the driving mode to a driving mode in which the first control device 100 controls the vehicle M, which is included in a plurality of driving modes, when the steering ECU 350 (second steering controller) controls the steering of the vehicle M (for example, when the second control device 300 is executing automated driving in the FOF mode), and maintains a state (FOF mode) in which the steering ECU 350 (the second steering controller) is made to control the steering.

The mode change processor 154 restricts the mode determiner 150 from setting the driving mode to the second driving mode (for example, the modes A to D) when a predetermined condition ((A) to (C) to be described below) is satisfied. When the steering ECU 250 controls the steering of the vehicle M and the driving mode is the second driving mode, restricting is, for example, to change the driving mode to the first driving mode (for example, the mode E). When the driving mode is the first driving mode (for example, manual driving or arbitrary driving mode), restricting is, for example, that it is restricted to change the driving mode from the first driving mode to the second driving mode (for example, the modes A to D).

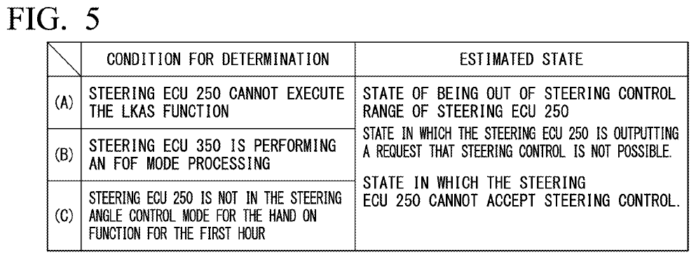

FIG. 5 is a diagram for describing predetermined conditions (A) to (C).

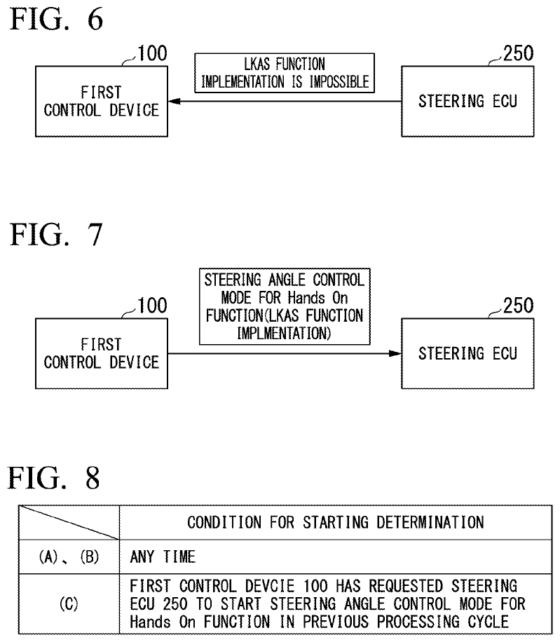

Condition (A) is that the steering ECU 250 cannot execute the LKAS function (the LKAS function cannot be implemented). Refer to FIG. 6 for details.

Condition (B) is that the steering ECU 350 is performing an FOF mode processing.

Condition (C) is that the steering ECU 250 is not in the steering angle control mode for the Hand On function for the first hour (for example, 0.1 [s]) or more. Refer to FIG. 7 for details.

When any one of the conditions (A) to (C) is satisfied, the following states are estimated. A state of being out of a steering control range of the steering ECU 250. For example, the steering control that exceeds a steering angle of the preset steering control is performed. A state in which the steering ECU 250 is outputting a request that steering control is not possible. A state in which the steering ECU 250 cannot accept steering control.

FIG. 6 is a diagram for describing the condition (A). The mode change processor 154 of the first control device 100 determines that the condition (A) is satisfied when it is notified of information indicating that the LKAS function cannot be executed from the steering ECU 250. The steering ECU 250 determines that the condition (A) is satisfied when a steering angle of the steering control exceeds a preset steering angle of the steering control, when the steering ECU 250 determined that the steering control is not possible on the basis of information acquired from a sensor for obtaining information for steering control (for example, a steering angle sensor that acquires an angle of the steering wheel or a steering torque sensor that acquires a torque applied around a rotational axis of the steering wheel), or when information is not obtained from the sensor described above.

FIG. 7 is a diagram for describing the condition (C). Although the mode change processor 154 of the first control device 100 provides the steering ECU 250 with information indicating implementation of the steering control mode for the Hand On function (the LKAS function executed when the driver touches the steering wheel), the steering control mode for the Hand On function is not executed. For example, when the vehicle M is traveling in a state in which the driver does not operate the steering wheel (the mode B or mode C), the first control device 100 provides the steering ECU 250 with a request to shift to a driving mode in which the LKAS function is executed (for example, a heavier mode than a mode in the state in which the steering wheel is not operated), in response to a driver's quick operation of the steering wheel. In this case, the steering ECU 250 may not be able to respond quickly to the request. In such a situation, the condition (C) described above may be satisfied. For example, the condition (C) may be satisfied when the steering wheel is gripped in the mode B or when torque is applied to the steering wheel in the mode C. When the condition (C) is satisfied, for example, it is suspected to have a state in which the control of the steering ECU 250 cannot quickly respond to a behavior of the driver, an abnormality of the steering ECU 250, or an abnormality of communication between the steering ECU 250 and the first control device 100.

For example, determination of an abnormality using the condition (A) described above may take a relatively long time, but determination of an abnormality using the condition (C) described above can be performed in a relatively shorter time than the determination using the (A) described above. In this manner, by determining whether the conditions (A) and (C) described above are satisfied, reliability of the determination of an abnormality is improved.

FIG. 8 is a diagram for describing a condition for starting to determine whether predetermined conditions (A) to (C) are satisfied. Determination on the condition (A) or (B) is always performed. The condition (C) is that the first control device 100 requested the steering ECU 250 to start a steering control mode for a Hand On function in the previous processing cycle.

[Flowchart]

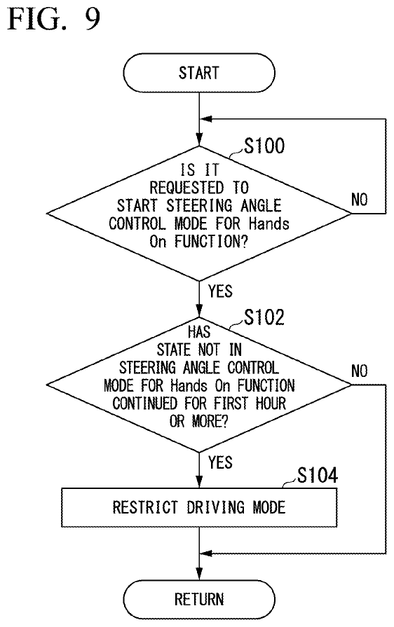

FIG. 9 is a flowchart which shows an example of a flow of processing executed by the mode change processor 154 of the first control device 100. In this flowchart, as an example, processing for determining whether the condition (C) is satisfied will be described.

First, the mode change processor 154 determines whether the mode determiner 150 has requested a start of the steering control mode for the Hand On function (step S100). When the start of the steering control mode is requested, the mode change processor 154 determines whether a state not in the steering angle control mode for the Hand On function has continued for a first hour or more (step S102). When it has not continued for the first hour or more, one routine of this flowchart ends, and when it has continued for the first hour or more, the mode change processor 154 restricts the driving mode (step S104). For example, the mode change processor 154 changes the driving mode to the mode E and maintains the driving mode of the mode E. As a result, processing of one routine of this flowchart ends.

Regarding the condition (A) or (B), for example, when power of the vehicle M is turned on or a drive source of the vehicle M is turned on, the mode change processor 154 determines that the condition (A) or (B). is satisfied, and restricts the driving mode when the condition is satisfied.

According to the processing described above, the vehicle system 1 can control the vehicle more appropriately by restricting the driving mode to be executed when the condition (A), the condition (B), or the condition (C) is satisfied.

According to the embodiment described above, when the driving mode is set to the second driving mode and the first steering controller is in a state in which the steering is not able to be controlled such that the vehicle travels in a lane in which the vehicle travels, the vehicle system 1 sets the driving mode to the first driving mode in which a task imposed on the driver is heavier than that of the second driving mode and, when the second steering controller is controlling the steering of the vehicle M, does not set the driving mode to a driving mode in which the first driving controller controls the vehicle M, which is included in a plurality of driving modes, and maintains a state in which the second steering controller is made to control the steering. As a result, it is possible to control the vehicle more appropriately.

Although a mode for carrying out the present invention has been described above using the embodiment, the present invention is not limited to the embodiment, and various modifications and substitutions can be made within a range not departing from the gist of the present invention.

### REFERENCE SIGNS LIST

1 Vehicle system
10 Camera
16 First recognition device
20 Communication device
40 Vehicle sensor
50 Navigation device
70 Driver monitor camera
80 Driving operator
82 Steering wheel
84 Steering grip sensor
100 First control device
120 First controller
130 Recognizer
140 Action plan generator
150 Mode determiner
152 Driver state determiner
154 Mode change processor
160 Second controller
162 Acquirer
164 Speed controller
166 Steering controller
170 First monitor
200 Traveling drive force output device
210 Brake device
220 Steering device
250 Steering ECU
252 Drive ECU
260 Braking ECU
262 Stop holding ECU
264 First notification ECU
266 External notification ECU
270 HUD
264 First notification ECU
266 External notification ECU
270 HUD
300 Second control device
310 Camera
312 Radar device
320 Second control device
330 Second recognizer
340 Vehicle controller
342 Second monitor
350 Steering ECU
362 Braking ECU
364 Stop holding ECU
366 Second notification ECU
400 Large-capacity battery
410 First power supply
420 First battery
430 Second power supply
440 Second battery

What is claim is:

1. A vehicle control system comprising:
a first driving controller configured to control steering and acceleration or deceleration of a vehicle;
a first steering controller configured to output a control command value according to a state of a steering device of the vehicle on the basis of an instruction of the first driving controller;
a second driving controller configured to control the steering and the acceleration or deceleration of the vehicle;
a second steering controller configured to output a control command value according to a state of the steering device on the basis of an instruction of the second driving controller; and
a mode setter configured to set a driving mode of the vehicle to any one of a plurality of driving modes, including a first driving mode in which a task of performing a predetermined amount of operations or more on a driving operator is imposed on the driver and a second driving mode in which the task is not imposed on the driver and the first steering controller controls the steering of the vehicle;
wherein the first steering controller controls the steering of the vehicle with preference over control by the second steering controller, and
the mode setter sets the driving mode to the first driving mode when the driving mode is set to the second driving mode and the first steering controller is in a state in which the steering is not able to be controlled such that the vehicle travels in a lane in which the vehicle travels, and
the mode setter does not set the driving mode to a driving mode in which the first driving controller controls the vehicle, which is included in the plurality of driving modes, and maintains a state in which the second steering controller is made to control the steering when the second steering controller controls the steering of the vehicle.

2. The vehicle control system according to claim 1,
wherein the first driving mode is a mode in which the driver performs a predetermined amount of operations or more on the driving operator to control the steering device.

3. The vehicle control system according to claim 1,
wherein the mode setter determines that the first steering controller is in a state in which the steering is not able to be controlled when information indicating that the vehicle is not able to be controlled to travel in a lane in which the vehicle travels is acquired from the first steering controller.

4. The vehicle control system according to claim 1,
wherein, even if the first driving controller requests the first steering controller to perform control such that the vehicle travels in a lane in which the vehicle travels, the mode setter determines that the first steering controller is in the state in which the steering is not able to be controlled when the first steering controller does not execute control according to the request for a predetermined time.

5. The vehicle control system according to claim 1,
wherein, when an abnormality occurs in the first driving controller, the first steering controller, or a control target of the first driving controller and the first driving controller is not able to control the vehicle, the second driving controller causes the second steering controller to control the steering.

6. The vehicle control system according to claim 5,
wherein the second driving controller causes the vehicle to decelerate or stop to minimize a movement risk of the vehicle.

7. A vehicle control method comprising:
controlling, by a first hardware processor, steering and acceleration or deceleration of a vehicle and setting a driving mode of the vehicle to one of a plurality of driving modes including a first driving mode and a second driving mode in which the first driving mode is a driving mode in which a task of performing a predetermined amount of operations or more on a driving operator is imposed on a driver, and the second driving mode is a driving mode in which the task is not imposed on the driver and the first steering controller controls the steering of the vehicle;
outputting, by a second hardware processor, a control command value according to a state of a steering device of the vehicle on the basis of an instruction of the first hardware processor;
controlling, by a third hardware processor, steering and acceleration or deceleration of the vehicle;
outputting, by a fourth hardware processor, a control command value according to the state of the steering device on the basis of an instruction of the third hardware processor; and
controlling, by the second hardware processor, the steering of the vehicle with preference over control by the fourth hardware processor,
wherein the first hardware processor sets the driving mode to the first driving mode when the driving mode is set to the second driving mode and the second hardware processor is in a state in which the steering is not able to be controlled such that the vehicle travels in a lane in which the vehicle travels, and
maintains a state in which the fourth hardware processor is made to control the steering without setting the driving mode to a driving mode in which the first hardware processor controls the vehicle, included in the plurality of driving modes, when the fourth hardware processor is controlling the steering of the vehicle.
